(19) United States
(12) Patent Application Publication
(10) Pub. No.: US 2023/0004006 A1
(43) Pub. Date: Jan. 5, 2023

(54) OPTICAL SYSTEM AND NEAR-EYE DISPLAY DEVICE

(71) Applicant: VIVO MOBILE COMMUNICATION CO., LTD., Dongguan (CN)

(72) Inventor: Weiping TANG, Dongguan (CN)

(73) Assignee: VIVO MOBILE COMMUNICATION CO., LTD., Dongguan (CN)

(21) Appl. No.: 17/939,937

(22) Filed: Sep. 7, 2022

Related U.S. Application Data
(63) Continuation of application No. PCT/CN2021/077595, filed on Feb. 24, 2021.

(30) Foreign Application Priority Data
Mar. 20, 2020 (CN) 202010202147.4

(51) Int. Cl. G02B 27/01; G02B 27/28

(52) U.S. Cl. CPC G02B 27/0172; G02B 27/286

(57) ABSTRACT

An optical system and a near-eye display device are provided. The optical system includes a light-emitting source, a light conversion unit, and a first reflection unit. The light conversion unit is on a light exit side of the light-emitting source, and a first surface of the light conversion unit faces a light exit surface of the light-emitting source. The first reflection unit is on a side of the light conversion unit away from the light-emitting source, and a first angle is provided between a second surface of the first reflection unit and the first surface. A first light emitted by the light-emitting source is converted by the light conversion unit into a second light, and the second light is reflected by the first reflection unit.

### CROSS-REFERENCE TO RELATED APPLICATIONS

The application is a continuation of International Application No. PCT/CN2021/077595, filed on Feb. 24, 2021, which claims priority to Chinese Patent Application No. 202010202147.4, filed on Mar. 20, 2020. The entire contents of each of the above-identified applications are expressly incorporated herein by reference.

### TECHNICAL FIELD

The present disclosure relates to the field of display technologies, and in particular, to an optical system and a near-eye display device.

### BACKGROUND

With the popularization of smart devices, Near-Eye Displays (NED) devices such as Augmented Reality (AR) devices gradually enter the consumer market. For ease of design, a current near-eye display device generally uses a Birdbath optical system. That is, natural light emitted by a display source is projected to a beam splitter. Part of the light is reflected by the beam splitter to a partial transmitting and partial reflecting mirror. Then, the light is reflected by the partial transmitting and partial reflecting mirror to the beam splitter, and passes through the beam splitter to reach human eyes to form a virtual image. Another part of the light directly reaches the human eyes through the beam splitter. This part of the light cannot be imaged and therefore becomes stray light. As a result, the display effect of the near-eye display device is affected.

### SUMMARY

Embodiments of the present disclosure provide an optical system and a near-eye display device.

According to a first aspect, an optical system is provided, including a light-emitting source, a light conversion unit, and a first reflection unit, where the light conversion unit is on a light exit side of the light-emitting source, and a first surface of the light conversion unit faces a light exit surface of the light-emitting source; and

the first reflection unit is on a side of the light conversion unit away from the light-emitting source, and a first angle is provided between a second surface of the first reflection unit and the first surface,

where, a first light emitted by the light-emitting source is converted by the light conversion unit into a second light, and the second light is reflected by the first reflection unit.

According to a second aspect, a near-eye display device is provided, including the optical system provided in the first aspect.

### BRIEF DESCRIPTION OF THE DRAWINGS

Accompanying drawings described herein are used for providing further understanding about the present disclosure, and constitute one portion of the present disclosure. Exemplary embodiments of the present disclosure and descriptions thereof are used for explaining the present disclosure, and do not constitute an inappropriate limitation on the present disclosure. In the accompanying drawings:

FIG. 1 is a schematic structural diagram of a current optical system;

FIG. 2 is a schematic structural diagram of an optical system according to an embodiment of the present disclosure; and

FIG. 3 is a schematic structural diagram of another optical system according to an embodiment of the present disclosure.

### DETAILED DESCRIPTION

The following describes the technical solutions in embodiments of the present disclosure with reference to the accompanying drawings in the embodiments of the present disclosure. Apparently, the described embodiments are some of the embodiments of the present disclosure rather than all of the embodiments. All other embodiments obtained by a person of ordinary skill in the art based on the embodiments of the present disclosure without creative efforts shall fall within the protection scope of the present disclosure.

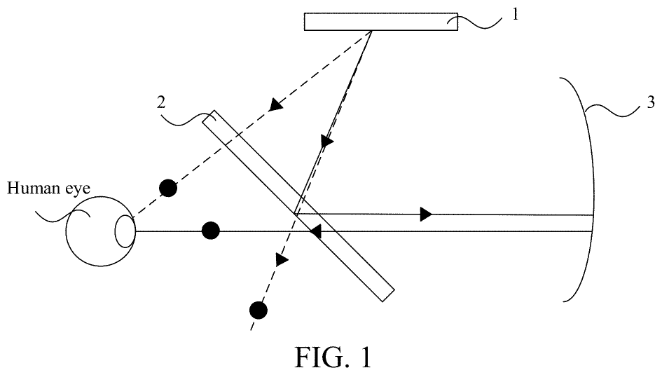

With the popularization of smart devices, near-eye display devices such as AR devices gradually enter the consumption field. For ease of production, a current near-eye display device generally uses a Birdbath optical system. As shown in FIG. 1, natural light emitted by a display source 1 is projected to a beam splitter 2. Part of the light (for example, solid lines in FIG. 1) is reflected by the beam splitter 2 to a partial transmitting and reflecting mirror 3, where the light is further reflected by the partial transmitting and reflecting mirror 3 to the beam splitter 2, and is transmitted through the beam splitter 2 to reach human eyes to form a virtual image. Another part of the light (for example, dashed lines in FIG. 1) directly reaches the human eyes through the beam splitter 2. This part of the light cannot be imaged and therefore becomes stray light, and as a result the imaging quality of the near-eye display device is affected. Black dots in the figure indicate that vibration directions are perpendicular to a paper surface.

In view of this, the embodiments of the present disclosure provide an optical system and a near-eye display device, to resolve the foregoing problems in a current near-eye display device.

The technical solutions provided in the embodiments of the present disclosure are described in detail below with reference to the accompanying drawings.

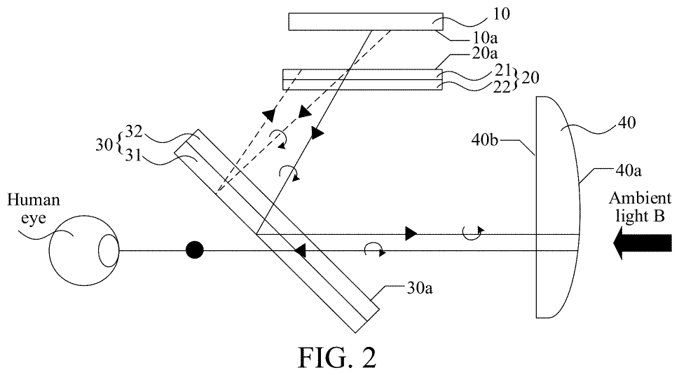

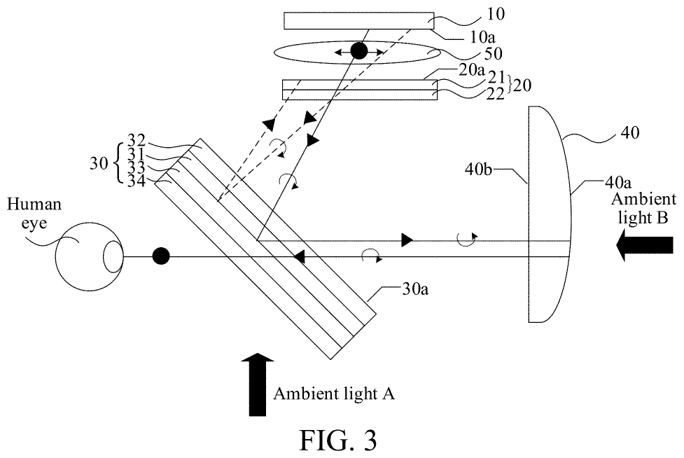

Referring to FIG. 2 and FIG. 3, the embodiments of the present disclosure provide an optical system. The optical system may be used in a near-eye display device such as an AR device. The optical system may include a light-emitting source 10, a light conversion unit 20, and a first reflection unit 30.

The light conversion unit 20 is on a light exit side of the light-emitting source 10, and a first surface 20a of the light conversion unit 20 faces a light exit surface 10a of the light-emitting source 10. The first reflection unit 30 is on a side of the light conversion unit 20 away from the light-emitting source 10, and a first angle is provided between a second surface 30a of the first reflection unit 30 and the first surface 20a of the light conversion unit 20.

In the optical system provided in the embodiments of the present disclosure, a first light (for example, dashed lines shown in the figures) emitted by the light-emitting source 10 is converted by the light conversion unit 20 into a second light, and the second light is reflected by the first reflection unit 30, so that the first light emitted by the light-emitting source 10 is prevented from directly reaching human eyes through the first reflection unit 30.

During application, a reflecting surface 40a of a reflecting lens 40 on a near-eye display device (such as AR glasses) faces the second surface 30a of the first reflection unit 30. Another part of the light (for example, solid lines shown in the figures) emitted by the light-emitting source 10 is converted by the light conversion unit 20, and a vibration direction of this part of the light is changed (for example, this part of the light is converted from natural light to circularly polarized light or elliptically polarized light). This part of the light is transmitted to the first reflection unit 30, reflected by the first reflection unit 30 to the reflecting surface 40a of the reflecting lens 40, then reflected by the reflecting surface 40a to the first reflection unit 30 and passes through the first reflection unit 30 to reach the human eyes, to form a virtual image.

It may be understood that since the first light emitted by the light-emitting source 10 is prevented from directly reaching human eyes, the imaging quality of the virtual image formed by another part of the light is not affected, so that the display effect of the near-eye display device and user experience can be improved.

For example, in the optical system provided in the embodiments of the present disclosure, the first angle between the first surface 20a of the light conversion unit 20 and the second surface 30a of the first reflection unit 30 is not less than 30 degrees and not greater than 60 degrees. Therefore, light projected by the light conversion unit 20 can be projected to the first reflection unit 30 and then reflected at an appropriate angle, thereby further eliminating stray light.

It should be noted that in the optical system provided in the embodiments of the present disclosure, the first angle between the first surface 20a and the second surface 30a is not limited to being between 30 degrees and 60 degrees. For example, the first angle may be less than 30 degrees, or the first angle may be greater than 60 degrees. In these cases, the first reflection unit 30 can also reflect the light projected by the light conversion unit 20 to eliminate stray light.

All components in the optical system provided in the embodiments of the present disclosure are described respectively below.

In an embodiment, the light-emitting source 10 in the optical system provided in the embodiments of the present disclosure may be a Liquid Crystal Display (LCD), an Organic Light-emitting Diode (OLED) display, or a display made of another material, which is not specifically limited herein.

In an embodiment, the light conversion unit 20 in the optical system provided in the embodiments of the present disclosure may include an absorptive polarizer 21 and a first phase retarder 22. The absorptive polarizer 21 includes the first surface 20a, and the first phase retarder 22 is on a side of the absorptive polarizer 21 away from the light-emitting source 10.

In this embodiment, the first light may be natural light, and the second light may be circularly polarized light or elliptically polarized light. The first light emitted by the light-emitting source 10 is converted by the absorptive polarizer 21 into linearly polarized light, and the linearly polarized light is converted by the first phase retarder 22 into the second light. The second light is reflected by the first reflection unit 30, transmitted to the first phase retarder 22 again, and is then converted by the first phase retarder 22 into linearly polarized light, a vibration direction of the linearly polarized light is changed, then the linearly polarized light is absorbed by the absorptive polarizer 21.

It may be understood that the natural light emitted by the light-emitting source 10 may be converted into linearly polarized light by using the absorptive polarizer 21, and a vibration direction of linearly polarized light transmitted from the absorptive polarizer 21 and a vibration direction of the light reflected back from the first reflection unit 30 can be adjusted by using the first phase retarder 22, so that the light reflected back from the first reflection unit 30 can be absorbed by the absorptive polarizer 21. Therefore, the light emitted by the light-emitting source 10 is prevented from reaching human eyes, thereby eliminating stray light and improving the display effect of the near-eye display device.

In some embodiments, to achieve better imaging quality, a second angle is provided between a transmission axis of the absorptive polarizer 21 and an optical axis of the first phase retarder 22. In some embodiments, the second angle may be 45 degrees. In this case, the second light converted by the first phase retarder 22 is circularly polarized light, and further obtained imaging quality is good.

In some embodiments, the second angle may be, for example, any other angle other than 45 degrees. In this case, the second light converted by the first phase retarder 22 is elliptically polarized light. The elliptically polarized light can also be reflected back by the first reflection unit 30 after being transmitted to the first reflection unit 30, and is then converted by the first phase retarder 22 again into linearly polarized light to be absorbed by the absorptive polarizer 21, thereby eliminating stray light.

In some embodiments, the absorptive polarizer 21 may be adhered to the first phase retarder 22. Therefore, in one aspect, a transmission path of light in the light conversion unit 20 can be shortened to reduce a light loss. In another aspect, the volume of the light conversion unit 20 can be reduced, thereby reducing a space of the optical system.

Correspondingly, the first reflection unit 30 in the optical system provided in the embodiments of the present disclosure may include a reflective polarizer 31 and a second phase retarder 32. The second phase retarder 32 includes the second surface 30a. The second surface 30a faces the light conversion unit 20. The reflective polarizer 31 is on a side of the second phase retarder 32 away from the light conversion unit 20, and a vibration direction of the reflective polarizer 31 is orthogonal to a vibration direction of the absorptive polarizer 21. For example, if the vibration direction of the reflective polarizer 31 is a P direction, the vibration direction of the absorptive polarizer 21 is an S direction. If the vibration direction of the reflective polarizer 31 is the S direction, the vibration direction of the absorptive polarizer 21 is the P direction.

In this embodiment, the second light converted and projected by the light conversion unit 20 is converted by the second phase retarder 32 into a third light. The third light is reflected by the reflective polarizer 31 to the second phase retarder 32 and converted by the second phase retarder 32 into a fourth light to be transmitted to the first phase retarder 22. The fourth light is converted by the first phase retarder 22 into a fifth light. The fifth light is absorbed by the absorptive polarizer 21.

For example, the first light may be natural light, the second light may be circularly polarized light, the third light may be linearly polarized light, the fourth light may be circularly polarized light, and the fifth light may be linearly polarized light, where a vibration direction of the third light is orthogonal to a vibration direction of the fifth light. For example, if the third light is P-polarized light, the fifth light is S-polarized light. If the third light is S-polarized light, the fifth light is P-polarized light.

It may be understood that in this embodiment, by using the reflective polarizer 31 with a vibration direction orthogonal to the vibration direction of the absorptive polarizer 21, the reflective polarizer 31 can reflect linearly polarized light transmitted from the absorptive polarizer 21. Through the cooperation between the second phase retarder 32 and the first phase retarder 22, a vibration direction of the linearly polarized light transmitted from the absorptive polarizer 21 can be adjusted, so that the linearly polarized light can be reflected by the reflective polarizer 31, and a vibration direction of linearly polarized light reflected by the reflective polarizer 31 to return to the absorptive polarizer 21 can also be adjusted, so that the linearly polarized light can be absorbed by the absorptive polarizer 21. Therefore, light emitted by the light-emitting source 10 is prevented from reaching human eyes, thereby eliminating stray light and improving the display effect of the near-eye display device.

In some embodiments, both the first phase retarder 22 and the second phase retarder 32 may be quarter-wave plates. When a quarter-wave plate is used as a phase retarder, the cost is low, the embodiment is simple, and the assembly is easy.

In some embodiments, to achieve better imaging quality, a third angle is provided between a transmission axis of the reflective polarizer 31 and an optical axis of the second phase retarder 32. For example, the third angle may be 45 degrees. In this case, both the third light and the fourth light converted by the second phase retarder 32 are circularly polarized light, and further obtained imaging quality is good.

In some embodiments, the third angle may be, for example, any other angle other than 45 degrees. In this case, both the third light and the fourth light converted by the second phase retarder 32 are elliptically polarized light, which can also achieve the effect of absorbing stray light.

In some embodiments, as shown in FIG. 3, the first reflection unit 30 may further include an absorptive polarizer 33 (to facilitate distinguishing from the absorptive polarizer 21 in the light conversion unit 20, the absorptive polarizer 21 is referred to as a first absorptive polarizer, and the absorptive polarizer 33 is referred to as a second absorptive polarizer). The absorptive polarizer 33 may be on a side of the reflective polarizer 31 away from the light conversion unit 20, and a vibration direction of the absorptive polarizer 33 is the same as the vibration direction of the reflective polarizer 31.

For example, when an environment in which the optical system is in has ambient light A that is transmitted to the first reflection unit 30 from a side of human eyes, the absorptive polarizer 33 can absorb all light with vibration directions different from the vibration direction of the absorptive polarizer 33 from the ambient light A. Therefore, polarized light that is in the ambient light A and has a vibration direction orthogonal to the vibration direction of the reflective polarizer 31 can be prevented from being reflected by the reflective polarizer 31 to the human eyes to form stray light and cause visual interference, and polarized light transmitted from the reflective polarizer 31 can be directly transmitted from the absorptive polarizer 33 to reach the human eyes, so that imaging is not affected.

In some embodiments, the reflective polarizer 31, the second phase retarder 32, and the absorptive polarizer 33 are adhered to each other. Therefore, in one aspect, a transmission path of light in the first reflection unit 30 can be shortened to reduce a light loss. In another aspect, the volume of the first reflection unit 30 can also be reduced, thereby further reducing the space of the optical system.

Further, as shown in FIG. 3, the first reflection unit 30 may further include plate glass 34, and the absorptive polarizer 33 is adhered to the plate glass 34. Therefore, aberration caused by uneven light passing through the first reflection unit 30 caused by wrinkling of any one of the reflective polarizer 31, the second phase retarder 32, and the absorptive polarizer 33 can be avoided, so that the imaging is not affected, thereby further improving the display effect of the near-eye display device.

In another embodiment, the optical system provided in the embodiments of the present disclosure may further include a second reflection unit 40. The second reflection unit 40 is on the side of the light conversion unit 20 away from the light-emitting source 10, and the reflecting surface 40a of the second reflection unit 40 faces the second surface 30a of the first reflection unit 30. In an actual application, the second reflection unit 40 may be used as a reflecting lens of the near-eye display device.

In the second reflection unit 40, a sixth light (for example, the solid lines shown in the figure) emitted by the light-emitting source is converted by the light conversion unit 20 into a seventh light. The seventh light is transmitted to the first reflection unit 30 and converted by the first reflection unit 30 into an eighth light to be reflected to the second reflection unit 40. The eighth light is then reflected by the second reflection unit 40 to the first reflection unit 30 and converted by the first reflection unit 30 into a ninth light to pass through the first reflection unit 30.

For example, the sixth light may be natural light, the seventh light may be circularly polarized light, the eighth light may be linearly polarized light, and a ninth light may be linearly polarized light. A vibration direction of the eighth light is orthogonal to a vibration direction of the ninth light. For example, if the eighth light is S-polarized light, the ninth light is P-polarized light. In some embodiments, if the eighth light is P-polarized light, the ninth light is S-polarized light.

It may be understood that the light emitted by the light-emitting source 10 sequentially passes through the light conversion unit 20, the first reflection unit 30, and the second reflection unit 40 to be projected to the first reflection unit 30, and is converted by the first reflection unit 30 to reach human eyes to form a virtual image, thereby implementing near-eye display.

It should be noted that, for an AR device, as shown in FIG. 2 and FIG. 3, the second reflection unit 40 may allow ambient light (such as ambient light B shown in the figures) from a side away from the first reflection unit 30 to pass through. This part of ambient light passes through the second reflection unit 40 to enter the first reflection unit 30, and is converted by the first reflection unit 30 to pass through the first reflection unit 30 to reach the human eyes to form a real image. Therefore, the formed real image and virtual image are combined and augment each other to form augmented reality AR display.

In an embodiment, the second reflection unit 40 may include a curved lens. A surface 40b of the curved lens facing the first reflection unit 30 is a plane, a surface of the curved lens away from the first reflection unit 30 is a curved surface 40a, and a concave surface of the curved surface 40a may be formed as a reflecting surface. Therefore, a dispersion degree of the curved surface can be reduced, which facilitates more stable reflection and transmission of light in the second reflection unit 40 and does not affect the imaging effect of the optical system.

In another embodiment, as shown in FIG. 3, the optical system provided in the embodiments of the present disclosure may further include a lens 50. The lens 50 is arranged between the light-emitting source 10 and the light conversion unit 20, and may correct the light emitted by the light-emitting source 10, thereby eliminating the aberration and therefore further improving the display effect of the near-eye display device. During application, a quantity of lenses 50 may be set according to an actual need. For example, there may be one or more lenses 50. This is not specifically limited herein.

It should be noted that, as shown in FIG. 2 and FIG. 3, black dots indicate that vibration directions are perpendicular to a paper surface, and rotation arrows indicate rotation directions of light.

The embodiments of this specification further provide a near-eye display device, including the optical system provided in the foregoing one or more embodiments.

It may be understood that in the embodiments of this specification, the near-eye display device may be an augmented reality device, a Virtual Reality (VR) device, or another near-eye display device, which is not specifically limited herein.

It should be noted that the term “comprise”, “include” or any other variation thereof in this specification is intended to cover a non-exclusive inclusion, which specifies the presence of stated processes, methods, objects, or apparatuses, but does not preclude the presence or addition of one or more other processes, methods, objects, or apparatuses. Without more limitations, elements defined by the sentence “including one” does not exclude that there are still other same elements in the processes, methods, objects, or apparatuses.

Through the descriptions of the foregoing embodiments, a person skilled in the art may clearly understand that the methods in the foregoing embodiments may be implemented by using software and a necessary general hardware platform, and in some embodiments, may also be implemented by using hardware. Based on such an understanding, the technical solutions of the present disclosure essentially, or the part contributing to the prior art, may be presented in the form of a software product. The computer software product is stored in a storage medium (for example, a ROM/RAM, a magnetic disk, or an optical disc) including several instructions to enable a terminal (which may be a mobile phone, a computer, a server, an air conditioner, a network device, or the like) to perform the methods described in the embodiments of the present disclosure.

The embodiments of the present disclosure are described above with reference to the accompanying drawings. However, the present disclosure is not limited to the foregoing specific embodiments. The foregoing specific embodiments are illustrative instead of limitative. Enlightened by the present disclosure, a person of ordinary skill in the art can make many forms without departing from the idea of the present disclosure and the scope of protection of the claims. All of the forms fall within the protection of the present disclosure.

What is claimed is:

1. An optical system, comprising:
a light-emitting source;
a light conversion unit; and
a first reflection unit,
wherein the light conversion unit is on a light exit side of the light-emitting source, and a first surface of the light conversion unit faces a light exit surface of the light-emitting source, and the first reflection unit is on a side of the light conversion unit away from the light-emitting source, and a first angle is provided between a second surface of the first reflection unit and the first surface, and
wherein a first light emitted by the light-emitting source is converted by the light conversion unit into a second light, and the second light is reflected by the first reflection unit.

2. The optical system according to claim 1, wherein the light conversion unit comprises an absorptive polarizer and a first phase retarder, and
wherein the absorptive polarizer comprises the first surface, and the first phase retarder is on a side of the absorptive polarizer away from the light-emitting source.

3. The optical system according to claim 2, wherein a second angle is provided between a transmission axis of the absorptive polarizer and an optical axis of the first phase retarder.

4. The optical system according to claim 2, wherein the first reflection unit comprises a reflective polarizer and a second phase retarder, the second phase retarder comprises the second surface, the second surface faces the light conversion unit, the reflective polarizer is on a side of the second phase retarder away from the light conversion unit, and a vibration direction of the reflective polarizer is orthogonal to a vibration direction of the absorptive polarizer, and
wherein the second light is converted by the second phase retarder into a third light, the third light is reflected by the reflective polarizer to the second phase retarder and converted by the second phase retarder into a fourth light to be transmitted to the first phase retarder, then the fourth light is converted by the first phase retarder into a fifth light, and the fifth light is absorbed by the absorptive polarizer.

5. The optical system according to claim 4, wherein the first light is natural light, the second light is circularly polarized light, the third light is a linearly polarized light, the fourth light is a circularly polarized light, and the fifth light is a linearly polarized light, and
wherein a vibration direction of the third light is orthogonal to a vibration direction of the fifth light.

6. The optical system according to claim 4, wherein the first phase retarder and the second phase retarder are quarter-wave plates.

7. The optical system according to claim 4, wherein a third angle is provided between an optical axis of the second phase retarder and a transmission axis of the reflective polarizer.

8. The optical system according to claim 1, wherein the optical system further comprises a second reflection unit, the second reflection unit is on the side of the light conversion unit away from the light-emitting source, and a reflecting surface of the second reflection unit faces the second surface of the first reflection unit, and
wherein a sixth light emitted by the light-emitting source is converted by the light conversion unit into a seventh light, the seventh light is transmitted to the first reflection unit and converted by the first reflection unit into an eighth light to be reflected to the second reflection unit, and the eighth light is then reflected by the second reflection unit to the first reflection unit and converted by the first reflection unit into a ninth light to pass through the first reflection unit.

9. The optical system according to claim 8, wherein the second reflection unit comprises a curved lens, a surface of the curved lens facing the first reflection unit is a plane, and a surface of the curved lens away from the first reflection unit is a curved surface.

10. The optical system according to claim 1, wherein the first angle is not less than 30 degrees and not greater than 60 degrees.

11. The optical system according to claim 1, wherein the optical system further comprises a lens, and the lens is arranged between the light-emitting source and the light conversion unit.

12. A near-eye display device, comprising an optical system, wherein the optical system comprises:
a light-emitting source;
a light conversion unit; and
a first reflection unit,
wherein the light conversion unit is on a light exit side of the light-emitting source, and a first surface of the light conversion unit faces a light exit surface of the light-emitting source, and the first reflection unit is on a side of the light conversion unit away from the light-emitting source, and a first angle is provided between a second surface of the first reflection unit and the first surface, and
wherein a first light emitted by the light-emitting source is converted by the light conversion unit into a second light, and the second light is reflected by the first reflection unit.

13. The near-eye display device according to claim 12, wherein the light conversion unit comprises an absorptive polarizer and a first phase retarder, and
wherein the absorptive polarizer comprises the first surface, and the first phase retarder is on a side of the absorptive polarizer away from the light-emitting source.

14. The near-eye display device according to claim 13, wherein a second angle is provided between a transmission axis of the absorptive polarizer and an optical axis of the first phase retarder.

15. The near-eye display device according to claim 13, wherein the first reflection unit comprises a reflective polarizer and a second phase retarder, the second phase retarder comprises the second surface, the second surface faces the light conversion unit, the reflective polarizer is on a side of the second phase retarder away from the light conversion unit, and a vibration direction of the reflective polarizer is orthogonal to a vibration direction of the absorptive polarizer, and
wherein the second light is converted by the second phase retarder into a third light, the third light is reflected by the reflective polarizer to the second phase retarder and converted by the second phase retarder into a fourth light to be transmitted to the first phase retarder, then the fourth light is converted by the first phase retarder into a fifth light, and the fifth light is absorbed by the absorptive polarizer.

16. The near-eye display device according to claim 15, wherein the first light is natural light, the second light is circularly polarized light, the third light is a linearly polarized light, the fourth light is a circularly polarized light, and the fifth light is a linearly polarized light, and
wherein a vibration direction of the third light is orthogonal to a vibration direction of the fifth light.

17. The near-eye display device according to claim 15, wherein the first phase retarder and the second phase retarder are quarter-wave plates.

18. The near-eye display device according to claim 15, wherein a third angle is provided between an optical axis of the second phase retarder and a transmission axis of the reflective polarizer.

19. The near-eye display device according to claim 12, wherein the optical system further comprises a second reflection unit, the second reflection unit is on the side of the light conversion unit away from the light-emitting source, and a reflecting surface of the second reflection unit faces the second surface of the first reflection unit, and
wherein a sixth light emitted by the light-emitting source is converted by the light conversion unit into a seventh light, the seventh light is transmitted to the first reflection unit and converted by the first reflection unit into an eighth light to be reflected to the second reflection unit, and the eighth light is then reflected by the second reflection unit to the first reflection unit and converted by the first reflection unit into a ninth light to pass through the first reflection unit.

20. The near-eye display device according to claim 19, wherein the second reflection unit comprises a curved lens, a surface of the curved lens facing the first reflection unit is a plane, and a surface of the curved lens away from the first reflection unit is a curved surface.
